(19) United States
(12) Patent Application Publication
(10) Pub. No.: US 2024/0405639 A1
(43) Pub. Date: Dec. 5, 2024

(54) OUTER-ROTOR-TYPE-ENGINE-DRIVEN-DC-OUTPUT UNIT

(71) Applicant: YAMAHA HATSUDOKI KABUSHIKI KAISHA, Iwata-shi (JP)

(72) Inventors: Masafumi MASUDA, Shizuoka (JP); Yasuhiro OKADA, Shizuoka (JP); Naoki KAWANO, Shizuoka (JP)

(21) Appl. No.: 18/807,535

(22) Filed: Aug. 16, 2024

Related U.S. Application Data
(63) Continuation-in-part of application No. PCT/JP2022/006594, filed on Feb. 18, 2022.

(51) Int. Cl. H02K 9/06; H02K 7/18; H02K 11/33

(52) U.S. Cl. CPC H02K 9/06; H02K 7/1807; H02K 11/33

(57) ABSTRACT

An DC output unit, having: an engine; a generator including an inner stator and an outer rotor; a converter converting electric power generated by the generator to DC power; a fan cooling the generator and the converter; and a cooling mechanism. The cooling mechanism includes a first intake system in which air drawn in through a first intake port passes subsequently by the inner stator of the generator, the fan, and a chassis of the converter, and a second intake system in which second air drawn in through a second intake port subsequently passes by the fan and then by the chassis without passing by the inner stator. The cooling mechanism is configured such that the first intake port, the inner stator, the fan, and the second intake port are arranged, in this order, in an axial direction of a rotation axis of the generator.

### CROSS-REFERENCES TO RELATED APPLICATIONS

This is a continuation-in-part application of International Application No. PCT/JP2022/006594 filed on Feb. 18, 2022, the contents of which are incorporated herein by reference.

### TECHNICAL FIELD

The present teaching relates to an outer-rotor-type-engine-driven-DC-output unit.

### BACKGROUND ART

An outer-rotor-type-engine-driven-DC-output unit in which an engine and an outer-rotor-type-electric generator to be driven by the engine are integrated as a unit is proposed. As such an outer-rotor-type-engine-driven-DC-output unit, Patent Document 1, for example, discloses a range extender and a controller-heat-dissipation device.

The range extender includes an air duct having an inlet connecting to the inside of a rotating machine and an outlet open to a controller. A casing of the rotating machine has an intake port. An outer rotor of the rotating machine includes a plurality of blades. The intake port and the blades cause air to be drawn into the rotating machine and cause a part of the air drawn into the rotating machine to flow to the controller through the airduct and cool the controller.

### CITATION LIST

### Patent Document

Patent Document 1: Chinese Utility Model application Ser. No. 210404946

### SUMMARY OF INVENTION

### Technical Problem

As in the range extender disclosed in Patent Document 1, for example, in an outer-rotor-type-engine-driven-DC-output unit for use in charging a battery, it is generally required to increase an output of the outer-rotor-type-engine-electric generator and convert electric power generated by the outer-rotor-type-engine-electric generator to direct current (DC) power by a DC-output-power converter for output.

In the outer-rotor-type-electric generator, however, an inner stator that generates heat is covered with a bottomed cylindrical outer rotor. Thus, in the case of increasing the output of the outer-rotor-type-electric generator, a cooling mechanism capable of enhancing cooling capability of the inner stator is needed.

With the increase of the output of the outer-rotor-type-electric generator, the amount of heat generation of the DC-output-power converter also increases. Therefore, a cooling mechanism capable of enhancing cooling capability of the DC-output-power converter is needed.

On the other hand, the outer-rotor-type-engine-driven-DC-output unit is expected to be mounted on a mobile object, and thus, is preferably configured as compactly as possible.

In view of this, there has been a demand for an outer-rotor-type-engine-driven-DC-output unit including a cooling mechanism capable of obtaining both cooling capability of an inner stator of an outer-rotor-type-electric generator and cooling capability of a DC-output-power converter that converts electric power generated by the outer-rotor-type-electric generator to DC power while suppressing size increase of the unit.

It is therefore an object of the present teaching to provide an outer-rotor-type-engine-driven-DC-output unit including a cooling mechanism capable of obtaining both cooling capability of an inner stator of an outer-rotor-type-electric generator and cooling capability of a DC-output-power converter that converts electric power generated by the outer-rotor-type-electric generator to DC power while suppressing size increase of the unit.

### SOLUTION TO PROBLEM

The inventors of the present teaching studied a configuration of an outer-rotor-type-engine-driven-DC-output unit including a cooling mechanism capable of obtaining both cooling capability of an inner stator of an outer-rotor-type-electric generator and cooling capability of a DC-output-power converter that converts electric power generated by the outer-rotor-type-electric generator to DC power while suppressing size increase of the unit. Through an intensive study, the inventors arrived at the following configuration.

An outer-rotor-type-engine-driven-DC-output unit according to one embodiment of the present teaching is an outer-rotor-type-engine-driven-DC-output unit including: an engine; an outer-rotor-type-electric generator including an inner stator and an outer rotor, the outer-rotor-type-electric generator being configured to be driven by the engine; a DC-output-power converter that includes a chassis, the DC-output-power converter being configured to convert electric power generated by the outer-rotor-type-electric generator to DC power, and to output the DC power; a fan configured to cool the outer-rotor-type-electric generator and the DC-output-power converter, wherein the engine, the outer-rotor-type-electric generator, the DC-output-power converter, and the fan are integrated as a unit; and a cooling mechanism including a first intake system in which first air drawn in by the fan through a first intake port passes around the inner stator of the outer-rotor-type-electric generator, then passes through the fan, and then passes around the chassis of the DC-output-power converter, and a second intake system in which second air drawn in by the fan through a second intake port passes through the fan and then passes around the chassis of the DC-output-power converter without passing around the inner stator of the outer-rotor-type-electric generator. The cooling mechanism is configured such that the first intake port, the inner stator, the fan, and the second intake port are arranged, in this order, in an axial direction of a rotation axis of the outer-rotor-type-electric generator, the inner stator is cooled by the first air before passing around the chassis of the DC-output-power converter, and the DC-output-power converter is cooled by both the first air in the first intake system after cooling the inner stator, and the second air in the second intake system, without the second air having been used for cooling the inner stator.

Accordingly, the inner stator can be cooled by the first intake system configured such that air drawn in through the first intake port flows in the inner stator, the fan, and the DC-output-power converter in this order. Together with the first intake system, the second intake system configured such that air drawn in through the second intake port flows in the fan and the DC-output-power converter in this order without passing around the inner stator can cool the DC-output-power converter.

In this manner, by cooling the DC-output-power converter with air flowing in the first intake system and air flowing in the second intake system, design flexibility concerning the temperature and amount of air to be sent around the chassis of the DC-output-power converter can be increased. Thus, with the configuration described above, it is possible to obtain cooling capability of the DC-output-power converter while obtaining cooling capability of the inner stator. Accordingly, both cooling capability of the inner stator and cooling capability of the DC-output-power converter can be obtained.

In addition, as described for the configuration mentioned above, the inner stator, the fan, the first intake port of the first intake system, and the second intake port of the second intake system are arranged in the order of the first intake port, the inner stator, the fan, and the second intake port, in the axial direction of the rotation axis of the outer-rotor-type-electric generator so that the first intake system and the second intake system can be configured compactly in the outer-rotor-type-engine-driven-DC-output unit.

Thus, it is possible to obtain the outer-rotor-type-engine-driven-DC-output unit including the cooling mechanism capable of obtaining both cooling capability of the inner stator of the outer-rotor-type-electric generator and cooling capability of the DC-output-power converter that converts electric power generated by the outer-rotor-type-electric generator to DC power while suppressing size increase of the unit.

In another aspect, the outer-rotor-type-engine-driven-DC-output unit preferably includes the following configuration. The first intake port includes a plurality of first intake ports, the second intake port includes a plurality of second intake ports, and the cooling mechanism is configured such that the inner stator is cooled by the first air passing through the plurality of first intake ports without passing through the plurality of second intake ports, and the DC-output-power converter is cooled by the first air that has passed through the plurality of first intake ports and the second air that has passed through the plurality of second intake ports.

With this configuration, cooling capability to the inner stator and cooling capability to the DC-output-power converter in the cooling mechanism can be adjusted by adjusting the numbers and sizes of the first intake ports and the second intake ports, for example. Thus, design flexibility of the cooling mechanism can be enhanced. As a result, it is also possible to enhance cooling capability to the inner stator and cooling capability to the DC-output-power converter.

In another aspect, the outer-rotor-type-engine-driven-DC-output unit preferably includes the following configuration. The outer-rotor-type-engine-driven-DC-output unit further includes an inner-stator-support-cover member supporting the inner stator, the inner-stator-support-cover member including an inner-stator-cover surface, a first space being defined between the inner-stator-cover surface and an end surface of the inner stator located farther from the fan in the axial direction; and a fan-support-cover member rotatably supporting a rotating shaft of the fan, the fan-support-cover member including a fan cover surface, a second space being defined between the fan cover surface and an end surface of the fan located farther from the inner stator in the axial direction. The first intake port is formed in the inner-stator-cover surface of the inner-stator-support-cover member at a position overlapping with at least a part of the inner stator when the inner-stator-cover surface is seen in the axial direction. The second intake port is formed in the fan cover surface of the fan-support-cover member at a position overlapping with at least a part of the fan when the fan cover surface is seen in the axial direction.

With this configuration, air is allowed to flow toward the inner stator from the first intake port provided in the inner-stator-cover surface of the inner-stator-support-cover member. Air is also allowed to flow toward the fan from the second intake port provided in the fan cover surface of the fan-support-cover member. Thus, with the configuration described above, air is allowed to flow efficiently in the first intake system and the second intake system. Accordingly, it is possible to obtain cooling capability of the inner stator of the outer-rotor-type-electric generator and cooling capability of the DC-output-power converter.

In addition, since the first intake port is provided in the inner-stator-cover surface of the inner-stator-support-cover member and the second intake port is provided in the fan cover surface of the fan-support-cover member, the first intake system and the second intake system can be configured compactly in the outer-rotor-type-engine-driven-DC-output unit.

As a result, it is possible to provide the outer-rotor-type-engine-driven-DC-output unit including the cooling mechanism capable of obtaining both cooling capability of the inner stator of the outer-rotor-type-electric generator and cooling capability of the DC-output-power converter that converts electric power generated by the outer-rotor-type-electric generator to DC power while suppressing size increase of the unit.

In another aspect, the outer-rotor-type-engine-driven-DC-output unit preferably includes the following configuration. A distance between the engine and at least a part of the second intake port is smaller than a distance between the engine and the first intake port. The DC-output-power converter is cooled by the second air around the engine drawn in through the second intake port.

With this configuration, air around the engine can be drawn in through the second intake port of the second intake system. Thus, stagnation of air around the engine can be reduced so that the engine can be thereby efficiently cooled with air at a stable temperature. As a result, cooling capability of the engine can be enhanced.

In another aspect, the outer-rotor-type-engine-driven-DC-output unit preferably includes the following configuration. The fan includes first blades constituting a part of the first intake system, and second blades constituting a part of the second intake system.

With this configuration, one fan can constitute a part of each of the two intake systems. Thus, the outer-rotor-type-engine-driven-DC-output unit including the two intake systems can be achieved with a compact configuration.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

An embodiment of an outer-rotor-type-engine-driven-DC-output unit according to the present teaching will be herein described.

In the following description, numerous specific details are set forth in order to provide a thorough understanding of the present invention. It will be evident, however, to one skilled in the art that the present invention may be practiced without these specific details.

The present disclosure is to be, therefore, considered as an exemplification of the invention, and is not intended to limit the invention to the specific embodiments illustrated by the figures or description below.

### Outer-Rotor-Type-Engine-Driven-DC-Output Unit

An outer-rotor-type-engine-driven-DC-output unit herein refers to a unit which includes an engine, an outer-rotor-type-electric generator, a DC-output-power converter, and a fan, converts electric power output from the outer-rotor-type-electric generator driven by the engine to DC power by the DC-output-power converter, and outputs the converted DC power. The outer-rotor-type-engine-driven-DC-output unit is attachable or detachable to/from an external load device.

### Intake System

An intake system herein refers to a configuration that is located in a unit and causes air drawn in by a fan (intake air) to flow in the unit. Specifically, the intake system includes a channel which is formed in the unit and in which air drawn in by the fan (intake air) flows, and also includes a plurality of components constituting the channel. The outer-rotor-type-engine-driven-DC-output unit herein includes a first intake system and a second intake system. The outer-rotor-type-engine-driven-DC-output unit may include another intake system other than the first intake system and the second intake system.

### Intake Port

An intake port herein refers to an intake port through which air flowing toward the outer-rotor-type-engine-electric generator is drawn and an intake port through which air flowing toward the DC-output-power converter is drawn, in the outer-rotor-type-engine-driven-DC-output unit. That is, the intake port herein is an intake port for air flowing toward the outer-rotor-type-engine-electric generator or the DC-output-power converter in the outer-rotor-type-engine-driven-DC-output unit.

### End Surface of Inner Stator Located in Axial Direction

End surfaces of an inner stator located in the axial direction herein refer to surfaces exposed in the axial direction at ends of the inner stator in the axial direction. The end surfaces of the inner stator located in the axial direction include, for example, surfaces of a stator core and a stator coil exposed in the axial direction.

### End Surface of Fan in Axial Direction

End surfaces of a fan in the axial direction herein refers to flat surfaces intersecting with the axis of a rotating shaft and including front ends of blades of the fan.

### Distance Between Engine and Intake Port

A distance between an engine and an intake port herein refers to a minimum distance between the engine and an opening end of an intake opening of the intake port.

### ADVANTAGEOUS EFFECTS OF INVENTION

According to one embodiment of the present teaching, it is possible to provide an outer-rotor-type-engine-driven-DC-output unit including a cooling mechanism capable of obtaining both cooling capability of an inner stator of an outer-rotor-type-electric generator and cooling capability of a DC-output-power converter that converts electric power generated by the outer-rotor-type-electric generator to DC power while suppressing size increase of the unit.

### BRIEF DESCRIPTION OF DRAWINGS

FIG. 1 is a cross-sectional view illustrating a schematic configuration of an engine-driven-DC-output unit according to an embodiment.

FIG. 2 is a side view schematically illustrating an air flow in the engine-driven-DC-output unit with arrows.

FIG. 3 is a side view of the engine-driven-DC-output unit when seen from one side in the axial direction.

FIG. 4 is a side view of the engine-driven-DC-output unit when seen from the other side in the axial direction.

### DESCRIPTION OF EMBODIMENTS

An embodiment will be described hereinafter with reference to the drawings. In the drawings, the same or corresponding parts are denoted by the same reference characters, and description thereof will not be repeated. The dimensions of components in the drawings do not strictly represent actual dimensions of the components and dimensional proportions of the components, for example.

In the following description, the top-bottom direction of an engine-driven-DC-output unit 1 refers to a top-bottom direction in a state where the engine-driven-DC-output unit 1 is placed such that an outer-rotor-type-electric generator 20 is located below a DC-output-power converter 30. The engine-driven-DC-output unit 1 may be placed in a manner different from that described above. That is, the top-bottom direction of the engine-driven-DC-output unit is not limited to the direction described above.

In the following description, the axial direction refers to a direction in which a crankshaft of an engine 10 and an axis P of a rotating shaft 15 connected to the crankshaft extend. The axial direction is the same as the axial direction of a rotation axis of the outer-rotor-type-electric generator 20. A radial direction refers to the radial direction of the outer-rotor-type-electric generator 20 and a fan 40. A circumferential direction refers to a rotation direction of the outer-rotor-type-electric generator 20 and the fan 40

### Overall Configuration

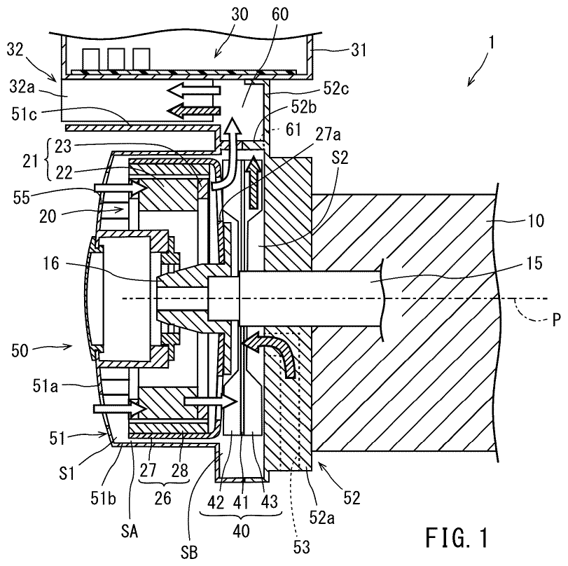

FIG. 1 is a cross-sectional view illustrating a schematic configuration of the engine-driven-DC-output unit 1 (outer-rotor-type-engine-driven-DC-output unit). The engine-driven-DC-output unit 1 includes the engine 10, the outer-rotor-type-electric generator 20, the DC-output-power converter 30, the fan 40, and a cover 50. In the engine-driven-DC-output unit 1, the DC-output-power converter 30 converts electric power generated by the outer-rotor-type-electric generator 20 driven by the engine 10 to DC power, and the DC power is output. In the engine-driven-DC-output unit 1, the engine 10, the outer-rotor-type-electric generator 20, the DC-output-power converter 30, and the fan 40 are integrated as a unit. The expression of “integrated as a unit” means that a plurality of parts are combined to be thereby configured as one unit.

The engine-driven-DC-output unit 1 may supply electric power to at least one of a motor or a battery as a driving source of a mobile object such as an automobile, for example. The mobile object refers to an object that is movable by power, such as an automobile, an aircraft, and a ship. The mobile object includes vehicles. The mobile object incorporates a power unit (e.g., a motor) that generates power from an energy source. In this embodiment, the energy source is, for example, the engine-driven-DC-output unit 1.

The engine-driven-DC-output unit 1 may be placed on a base or the ground, for example. The engine-driven-DC-output unit 1 may charge a battery of the mobile object, for example. The battery of the mobile object may be detachably attached to the mobile object or may be fixed to the mobile object. The engine-driven-DC-output unit 1 may charge a battery of a device such as an electric tool or an electric work machine, for example. The engine-driven-DC-output unit 1 may supply electric power to a device such as an illumination device, for example. The engine-driven-DC-output unit 1 may supply electric power to a driving source such as a motor of a pump and a motor of a compressor, for example.

Although not particularly shown, the engine 10 includes an engine body that rotates a crankshaft. The engine 10 may also include an intake pipe, an air cleaner, an exhaust pipe, an exhaust gas processing device, for example, as well as the engine body. The crankshaft rotates about the axis P. The crankshaft is connected to the rotating shaft 15 that rotates an outer rotor 26 of the outer-rotor-type-electric generator 20 and the fan 40, which will be described later.

The outer-rotor-type-electric generator 20 includes an inner stator 21 and the outer rotor 26.

The inner stator 21 includes a cylindrical stator core 22 and a stator coil 23. The stator core 22 is supported by a bottom portion 51a of an electric generator cover 51 described later. The stator coil 23 is wound around a plurality of teeth of the stator core 22.

The outer rotor 26 includes a bottomed cylindrical rotor magnet support 27 and rotor magnets 28. The rotor magnets 28 are fixed to the inner peripheral surface of the rotor magnet support 27. The rotor magnet support 27 is configured such that the rotor magnets 28 are located radially outward of the inner stator 21. The bottom portion of the rotor magnet support 27 is fixed to a bracket 16 located on the outer peripheral surface of the rotating shaft 15 connected to the crankshaft. Accordingly, the rotor magnet support 27 rotates together with the crankshaft through the rotating shaft 15 and the bracket 16. The bottom portion of the rotor magnet support 27 has a plurality of openings 27a through which air that has cooled the inner stator 21 flows.

The fan 40 is fixed to the rotating shaft 15. That is, the fan 40 also rotates together with the rotating shaft 15. The fan 40 is located between the outer-rotor-type-electric generator 20 and the engine 10 in the axial direction. The fan 40 includes a base 41, a plurality of first blades 42, and a plurality of second blades 43. The fan 40 is a centrifugal fan.

The base 41 has a plate shape fixed to the rotating shaft 15. The plurality of first blades 42 extend from the base 41 toward the outer-rotor-type-electric generator 20. The plurality of second blades 43 extends from the base 41 toward the engine 10. Each of the first blades 42 and the second blades 43 constitutes a part of the centrifugal fan.

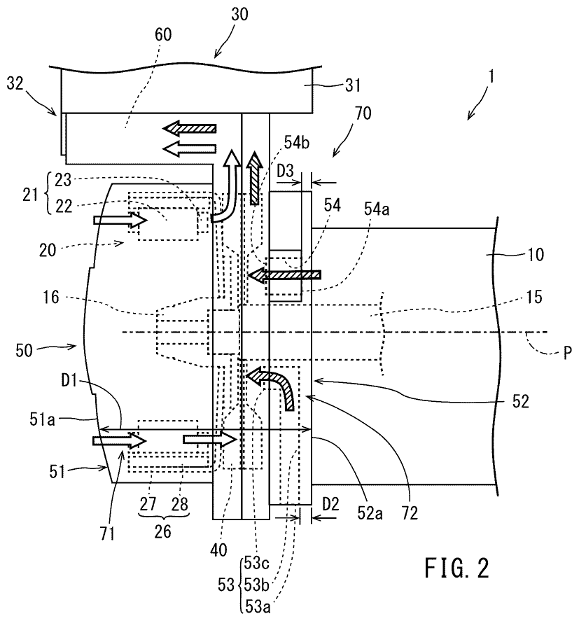

With this configuration of the fan 40, when the fan 40 rotates together with the rotating shaft 15, the fan 40 draws in air inside the outer-rotor-type-electric generator 20 and also draws in air around the engine 10, and discharges the intake air radially outward (see FIG. 2). With the configuration of the fan 40 described above, two intake systems described later can be achieved with a compact configuration.

As illustrated in FIG. 1, the outer-rotor-type-electric generator 20 and the fan 40 are housed in the cover 50. The cover 50 includes the electric generator cover 51 (inner-stator-support-cover member), and a fan cover 52 (fan-support-cover member). The electric generator cover 51 and the fan cover 52 are arranged side by side in the axial direction and connected to each other.

The electric generator cover 51 houses the outer-rotor-type-electric generator 20. The electric generator cover 51 is a bottomed cylindrical member including the disc-shaped bottom portion 51a and a cylindrical side wall 51b. In this manner, an electric-generator-housing space SA for housing the outer-rotor-type-electric generator 20 is defined inside the electric generator cover 51. The electric generator cover 51 is disposed such that the bottom portion 5la thereof covers one of end portions of the outer-rotor-type-electric generator 20 in the axial direction located farther from the fan 40. The bottom portion 51a of the electric generator cover 51 constitutes an inner-stator-cover surface defining a first space S1 between the inner-stator-cover surface and an end surface of the inner stator 21 in the axial direction located farther from the fan 40. The end surfaces of the inner stator 21 in the axial direction mean surfaces exposed in the axial direction at ends of the inner stator 21 in the axial direction. The end surfaces of the inner stator 21 in the axial direction include, for examples surfaces of the stator core 22 and the stator coil 23 exposed in the axial direction.

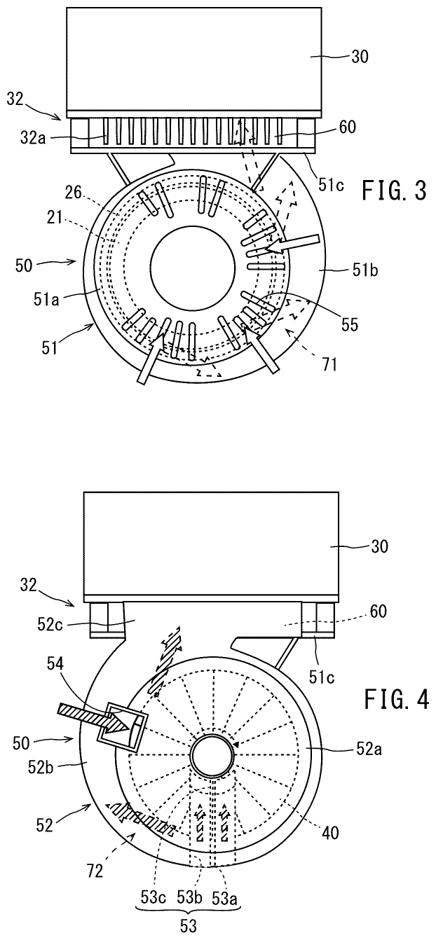

The bottom portion 51a of the electric generator cover 51 supports the stator core 22 of the inner stator 21. That is, the electric generator cover 51 functions as an inner-stator-support-cover member supporting the inner stator 21. As illustrated in FIG. 3, the bottom portion 51a of the electric generator cover 51 has a plurality of openings 55 at positions overlapping with the inner stator 21 when seen in the axial direction.

As illustrated in FIG. 1, the fan cover 52 covers a portion of the engine 10 near the outer-rotor-type-electric generator 20. The fan cover 52 is a bottomed cylindrical member including a disc-shaped bottom portion 52a and a cylindrical side wall 52b. A fan housing space SB that houses the fan 40 is defined inward of a portion where the side wall 51b of the electric generator cover 51 and the side wall 52b of the fan cover 52 are connected. The portion where the side wall 51b of the electric generator cover 51 and the side wall 52b of the fan cover 52 are connected has an opening 61 connecting the fan housing space SB to a cooling passage 60 described later.

The bottom portion 52a of the fan cover 52 partitions the space housing the fan 40 and a space surrounding the engine 10 in the axial direction. The bottom portion 52a of the fan cover 52 constitutes a fan cover surface that defines a second space S2 between the fan cover surface and an end surface of the fan 40 in the axial direction located farther from the inner stator 21. The rotating shaft 15 is rotatably supported by the bottom portion 52a of the fan cover 52 while penetrating the bottom portion 52a. That is, the fan cover 52 serves as a fan-support-cover member that rotatably supports the rotating shaft 15. The end surfaces of the fan 40 in the axial direction mean plan surfaces intersecting with the axis P of the rotating shaft 15 and plan surfaces including the front ends of the first blades 42 or the front ends of the second blades 43.

As illustrated in FIG. 2, the bottom portion 52a of the fan cover 52 has a first through hole 53 and a second through hole 54. The first through hole 53 includes an intake opening 53a that is open in a lower part of the bottom portion 52a, an inner passage 53b extending in the radial direction from the intake opening 53a toward the rotating shaft 15 in the bottom portion 52a, and a discharge opening 53c that is open to the fan housing space SB in an upper portion of the inner passage 53b. Accordingly, the first through hole 53 allows air below the engine-driven-DC-output unit 1 to be drawn into the fan housing space SB.

The second through hole 54 penetrates the bottom portion 52a in the axial direction, connects space surrounding the engine 10 and the fan housing space SB to the bottom portion 52a. An intake opening 54a of the second through hole 54 is open to the space surrounding the engine 10. A discharge opening 54b of the second through hole 54 is open to the fan housing space SB. Accordingly, the second through hole 54 allows air around the engine 10 to be drawn into the fan housing space SB.

A distance D2 between the engine 10 and the first through hole 53 is smaller than a distance D1 between the engine 10 and the openings 55. A distance D3 between the engine 10 and the second through hole 54 is smaller than the distance D1 between the engine 10 and the openings 55.

Here, the distance D2 between the engine 10 and the first through hole 53 is a minimum distance between the engine 10 and the opening end of the intake opening 53a of the first through hole 53. The distance D3 between the engine 10 and the second through hole 54 is a minimum distance between the engine 10 and the opening end of the intake opening 54a of the second through hole 54. The distance D1 between the engine 10 and the openings 55 is a minimum distance between the engine 10 and the opening end of the intake opening of the openings 55. The intake opening of the openings 55 is formed in the inner surface of the bottom portion 51a of the electric generator cover 51.

Accordingly, air around the engine 10 can be drawn into the fan housing space SB through the first through hole 53 and the second through hole 54. Accordingly, stagnation of air around the engine 10 can be reduced so that the engine 10 can be thereby efficiently cooled.

Although not particularly illustrated, the engine-driven-DC-output unit 1 may or may not be covered with a cover. The engine 10 may or may not be covered with a cover. As long as air around the engine 10 can be drawn in by the fan, the fan cover 52 may not be provided. In either case, as long as air around the engine 10 can be drawn in by the fan 40, stagnation of air around the engine 10 can be reduced so that cooling capability of the engine 10 can be thereby enhanced.

As illustrated in FIG. 4, in this embodiment, the first through hole 53 and the second through hole 54 are located at positions at least partially overlapping with the fan 40 when the bottom portion 52a of the fan cover 52 is seen in the axial direction. Accordingly, the fan 40 can efficiently draw air into the fan housing space SB through the first through hole 53 and the second through hole 54.

As illustrated in FIG. 1, a passage side wall 51c constituting a part of the cooling passage 60 of the DC-output-power converter 30 described later is located radially outward of the side wall 51b of the electric generator cover 51. The passage side wall 51c has a flat plate shape disposed in parallel with the axis P of the rotating shaft 15. The passage side wall 51c is integrally formed with the side wall 51b.

A passage side wall 52c constituting a part of the cooling passage 60 of the DC-output-power converter 30 is located radially outward of the side wall 52b of the fan cover 52. The passage side wall 52c is flat and has a sector shape extending in the radial direction and in the circumferential direction. The passage side wall 52c is integrally formed with the side wall 52b.

As described above, the passage side wall 51c and the passage side wall 52c constitute the cooling passage 60. In this cooling passage 60, a heat sink 32 for cooling the DC-output-power converter 30 is disposed.

The DC-output-power converter 30 converts electric power output from the outer-rotor-type-electric generator 20 to DC power and outputs the DC power. The DC-output-power converter 30 has a configuration capable of converting alternating current (AC) power to DC power. The DC-output-power converter 30 includes, for example, a plurality of switching elements. A specific configuration of the DC-output-power converter 30 will not be described.

The DC-output-power converter 30 includes a chassis 31. The chassis 31 is a rectangular parallelepiped case. Under the chassis 31, the heat sink 32 for cooling the DC-output-power converter 30 is located. The heat sink 32 includes a plurality of plate-shaped fins 32a extending in parallel. The heat sink 32 is disposed in the cooling passage 60 such that the plurality of fins 32a extend along an air flow in the cooling passage 60.

### Cooling Mechanism

The thus-configured engine-driven-DC-output unit 1 includes a cooling mechanism 70 that cools the outer-rotor-type-electric generator 20 and the DC-output-power converter 30. FIG. 2 is a view schematically illustrating an air flow in the engine-driven-DC-output unit 1 by the cooling mechanism 70.

The cooling mechanism 70 draws air into the inner stator 21 of the outer-rotor-type-electric generator 20 through the openings 55 (see FIG. 3) formed in the bottom portion 51a of the electric generator cover 51 with the fan 40 to cause the air to flow into the heat sink 32 of the DC-output-power converter 30, and draws in air through the first through hole 53 and the second through hole 54 formed in the bottom portion 52a of the fan cover 52 to cause the air to flow into the heat sink 32 of the DC-output-power converter 30 without passing through the outer-rotor-type-electric generator 20.

Specifically, the cooling mechanism 70 includes a first intake system 71 and a second intake system 72. Each intake system includes a channel which is formed in the engine-driven-DC-output unit 1 and in which air to be drawn by the fan 40 flows, and also includes a plurality of components constituting the channel.

As indicated by white arrows in FIG. 2, the first intake system 71 is an intake system in which air drawn in by the fan 40 through the openings 55 (first intake ports, see FIG. 3) of the electric generator cover 51 passes around the inner stator 21 of the outer-rotor-type-electric generator 20 and then passes through the fan 40 to pass around the chassis 31 of the DC-output-power converter 30. The first intake system 71 is also indicated by white arrows in FIGS. 1 and 3.

As indicated by hatched arrows in FIG. 2, the second intake system 72 is an intake system in which air drawn in by the fan 40 through the first through hole 53 and the second through hole 54 (second intake ports) formed in the fan cover 52 passes through the fan 40 without passing around the inner stator 21 of the outer-rotor-type-electric generator 20 and passes around the chassis 31 of the DC-output-power converter 30. The second intake system 72 is also indicated by hatched arrows in FIGS. 1 and 4.

Here, the inner stator 21 of the outer-rotor-type-electric generator 20, the fan 40, the openings 55 of the electric generator cover 51, and the first through hole 53 and the second through hole 54 of the fan cover 52 are arranged in the order of the openings 55 of the electric generator cover 51, the inner stator 21, the fan 40, and the first through hole 53 and the second through hole 54 of the fan cover 52, in the axial direction of the rotation axis of the outer-rotor-type-electric generator 20.

In the cooling mechanism 70, the inner stator 21 of the outer-rotor-type-electric generator 20 is cooled by air before passing around the chassis 31 of the DC-output-power converter 30. The DC-output-power converter 30 is cooled by both air that has flowed in the first intake system 71 and cooled the inner stator 21 and air that has flowed in the second intake system 72 but without cooling the inner stator 21.

In the manner described above, the DC-output-power converter 30 is cooled by air flowing in the first intake system 71 and air flowing in the second intake system 72 so that design flexibility concerning the temperature and amount of air to be sent around the chassis 31 of the DC-output-power converter 30 can be thereby increased. Thus, with the configuration described above, it is possible to obtain cooling capability of the DC-output-power converter 30 while obtaining cooling capability of the inner stator 21. Thus, both cooling capability of the inner stator 21 and cooling capability of the DC-output-power converter 30 can be obtained.

In addition, as described for the configuration described above, the inner stator 21, the fan 40, the openings 55 of the electric generator cover 51 in the first intake system 71, and the first through hole 53 and the second through hole 54 of the fan cover 52 in the second intake system 72 are arranged in the order of the openings 55 of the electric generator cover 51, the inner stator 21, the fan 40, and the first through hole 53 and the second through hole 54 of the fan cover 52 in the axial direction of the rotation axis of the outer-rotor-type-electric generator 20 so that the first intake system 71 and the second intake system 72 can be configured compactly in the engine-driven-DC-output unit 1.

Thus, it is possible to achieve the engine-driven-DC-output unit 1 including the cooling mechanism 70 capable of obtaining both cooling capability of the inner stator 21 and cooling capability of the DC-output-power converter 30 that converts electric power generated in the outer-rotor-type-electric generator 20 to DC power, while suppressing size increase of the unit.

The cooling mechanism 70 includes the plurality of openings 55 of the electric generator cover 51 as the first intake ports of the first intake system 71, and the plurality of through holes 53 and 54 of the fan cover 52 as the second intake ports of the second intake system 72. In the cooling mechanism 70, the inner stator 21 is cooled by air passing through the plurality of first intake ports without passing through the plurality of second intake ports, and the DC-output-power converter 30 is cooled by air that has passed through the plurality of first intake ports and air that has passed through the plurality of second intake ports.

Accordingly, cooling capability to the inner stator 21 and cooling capability to the DC-output-power converter 30 in the cooling mechanism 70 can be adjusted by adjusting the numbers and sizes of the first intake ports and the second intake ports, for example. Thus, design flexibility of the cooling mechanism 70 can be enhanced. As a result, it is also possible to enhance cooling capability of the inner stator 21 and cooling capability of the DC-output-power converter 30.

The engine-driven-DC-output unit 1 further includes: the electric generator cover 51 that includes the bottom portion 51a defining the first space S1 in the axial direction between the bottom portion 51a and the end surface of the inner stator 21 in the axial direction located farther from the fan 40 and supports the inner stator 21; and the fan cover 52 including the bottom portion 52a defining the second space S2 between the bottom portion 52a and the end surface of the fan 40 in the axial direction located farther from the inner stator 21 and rotatably supporting the rotating shaft 15. The openings 55 as the first intake ports are formed in the bottom portion 51a of the electric generator cover 51 at positions overlapping with at least a part of the inner stator 21 when the bottom portion 51a is seen in the axial direction. The first through hole 53 and the second through hole 54 as second intake ports are formed in the bottom portion 52a of the fan cover 52 at positions overlapping with at least a part of the fan 40 when the bottom portion 52a is seen in the axial direction.

Accordingly, air can flow toward the inner stator 21 through the openings 55 formed in the bottom portion 51a of the electric generator cover 51. Air can flow toward the fan 40 through the first through hole 53 and the second through hole 54 formed in the bottom portion 52a of the fan cover 52. Thus, the configuration described above enables air to flow efficiently in the first intake system 71 and the second intake system 72. Accordingly, it is possible to obtain cooling capability of the inner stator 21 of the outer-rotor-type-electric generator 20 and cooling capability of the DC-output-power converter 30.

Furthermore, since the openings 55 are located in the bottom portion 51a of the electric generator cover 51 and the first through hole 53 and the second through hole 54 are located in the bottom portion 52a of the fan cover 52, the first intake system 71 and the second intake system 72 can be configured compactly in the engine-driven-DC-output unit 1.

Thus, it is possible to provide the engine-driven-DC-output unit 1 including the cooling mechanism 70 capable of obtaining both cooling capability of the inner stator 21 of the outer-rotor-type-electric generator 20 and cooling capability of the DC-output-power converter 30 that converts electric power generated in the outer-rotor-type-electric generator 20 to DC power, while suppressing size increase of the unit.

At least parts of the first through hole 53 and the second through hole 54 as the second intake ports are formed at positions at each of which the distance between the engine 10 and the second intake port is smaller than the distance between the engine 10 and the first intake port. The cooling mechanism 70 is configured to cool the DC-output-power converter 30 with air around the engine 10 drawn in through the second intake ports.

Thus, air around the engine 10 can be drawn in through the first through hole 53 and the second through hole 54 of the second intake system 72. Accordingly, stagnation of air around the engine 10 can be reduced so that the engine 10 can be thereby efficiently cooled with air at a stable temperature. As a result, cooling capability of the engine 10 can be enhanced.

### OTHER EMBODIMENTS

The embodiment of the present teaching has been described above, but the above embodiment is merely an example for carrying out the teaching. Thus, the present teaching is not limited to the embodiment described above, and the embodiment may be modified as necessary within a range not departing from the gist of the present teaching.

In the embodiment, the engine-driven-DC-output unit 1 includes the plurality of openings 55 of the electric generator cover 51 as the first intake ports, and the first through hole 53 and the second through hole 54 of the fan cover 52 as the second intake ports. Alternatively, the engine-driven-DC-output unit may include only one first intake port and/or may include only one second intake port.

In the embodiment, the plurality of openings 55 of the electric generator cover 51 are formed in the bottom portion 51a of the electric generator cover 51 at positions overlapping with at least a part of the inner stator 21 when the bottom portion 51a is seen in the axial direction. Alternatively, the openings of the electric generator cover may be formed in the bottom portion of the electric generator cover at positions without overlapping with the inner stator when the bottom portion is seen in the axial direction.

In the embodiment, the first through hole 53 and the second through hole 54 of the fan cover 52 are formed in the bottom portion 52a of the fan cover 52 at positions overlapping with at least a part of the fan 40 when the bottom portion 52a is seen in the axial direction. Alternatively, at least one of the first through hole or the second through hole of the fan cover may be formed in the bottom portion of the fan cover at a position without overlapping with the fan when the bottom portion is seen in the axial direction.

In the embodiment, air around the engine 10 is drawn in through the first through hole 53 and the second through hole 54 of the fan cover 52. Alternatively, air other than the air around the engine may be drawn in through at least one of the first through hole or the second through hole of the fan cover.

In the embodiment, the engine-driven-DC-output unit 1 includes the electric generator cover 51 and the fan cover 52. Alternatively, the engine-driven-DC-output unit may be without at least one of the electric generator cover or the fan cover. The engine-driven-DC-output unit may be at least partially covered with a cover or may not be covered with a cover. The engine may or may not be covered with a cover.

In the embodiment, the fan 40 includes the first blades 42 constituting a part of the first intake system 71, and the second blades 43 constituting a part of the second intake system 72. Alternatively, the fan constituting a part of the first intake system and the fan constituting a part of the second intake system may be different fans.

### REFERENCE SIGNS LIST

### 1 Engine-Driven-DC-Output Unit (Outer-Rotor-Type-Engine-Driven-DC-Output Unit)

10 engine
15 rotating shaft
16 bracket
20 outer-rotor-type-electric generator
21 inner stator
22 stator core
23 stator coil
26 outer rotor
27 rotor magnet support
27a opening
28 rotor magnet
30 DC-output-power converter
31 chassis
32 heat sink
32a fin
40 fan
41 base
42 first blade
43 second blade
50 cover
51 electric generator cover (inner-stator-support-cover member)
51a bottom portion
51b side wall
51c passage side wall
52 fan cover (fan-support-cover member)
52a bottom portion
52b side wall
52c passage side wall
53 first through hole (second intake port)
53a intake opening
53b inner passage
53c discharge opening
54 second through hole (second intake port)
54a intake opening
54b discharge opening
55 opening (first intake port)
60 cooling passage
61 opening
70 cooling mechanism
71 first intake system
72 second intake system
SA electric-generator-housing space
SB fan housing spacc
S1 first space
S2 second space

1. An outer-rotor-type-engine-driven-DC-output unit comprising:
an engine;
an outer-rotor-type-electric generator including an inner stator and an outer rotor, the outer-rotor-type-electric generator being configured to be driven by the engine;
a DC-output-power converter that includes a chassis, the DC-output-power converter being configured to convert electric power generated by the outer-rotor-type-electric generator to DC power, and to output the DC power;
a fan configured to cool the outer-rotor-type-electric generator and the DC-output-power converter, wherein the engine, the outer-rotor-type-electric generator, the DC-output-power converter, and the fan are integrated as a unit; and
a cooling mechanism including
a first intake system in which first air drawn in by the fan through a first intake port passes around the inner stator of the outer-rotor-type-electric generator, then passes through the fan, and then passes around the chassis of the DC-output-power converter, and
a second intake system in which second air drawn in by the fan through a second intake port passes through the fan and then passes around the chassis of the DC-output-power converter without passing around the inner stator of the outer-rotor-type-electric generator,
the cooling mechanism being configured such that
the first intake port, the inner stator, the fan, and the second intake port are arranged, in this order, in an axial direction of a rotation axis of the outer-rotor-type-electric generator,
the inner stator is cooled by the first air before passing around the chassis of the DC-output-power converter, and
the DC-output-power converter is cooled by both the first air in the first intake system after cooling the inner stator, and the second air in the second intake system, without the second air having been used for cooling the inner stator.

2. The outer-rotor-type-engine-driven-DC-output unit according to claim 1, wherein
the first intake port comprises a plurality of first intake ports,
the second intake port comprises a plurality of second intake ports, and
the cooling mechanism is configured such that
the inner stator is cooled by the first air passing through the plurality of first intake ports without passing through the plurality of second intake ports, and
the DC-output-power converter is cooled by the first air that has passed through the plurality of first intake ports and the second air that has passed through the plurality of second intake ports.

3. The outer-rotor-type-engine-driven-DC-output unit according to claim 1 or 2, further comprising:
an inner-stator-support-cover member supporting the inner stator, the inner-stator-support-cover member including an inner-stator-cover surface, a first space being defined between the inner-stator-cover surface and an end surface of the inner stator located farther from the fan in the axial direction; and
a fan-support-cover member rotatably supporting a rotating shaft of the fan, the fan-support-cover member including a fan cover surface, a second space being defined between the fan cover surface and an end surface of the fan located farther from the inner stator in the axial direction, wherein
the first intake port is formed in the inner-stator-cover surface of the inner-stator-support-cover member at a position overlapping with at least a part of the inner stator when the inner-stator-cover surface is seen in the axial direction, and
the second intake port is formed in the fan cover surface of the fan-support-cover member at a position overlapping with at least a part of the fan when the fan cover surface is seen in the axial direction.

4. The outer-rotor-type-engine-driven-DC-output unit according to claim 1, wherein
a distance between the engine and at least a part of the second intake port is smaller than a distance between the engine and the first intake port, and
the DC-output-power converter is cooled by the second air around the engine drawn in through the second intake port.

5. The outer-rotor-type-engine-driven-DC-output unit according to claim 1, wherein the fan includes
a first blade constituting a part of the first intake system, and
a second blade constituting a part of the second intake system.
